(19) United States
(12) Patent Application Publication
(10) Pub. No.: US 2025/0132496 A1
(43) Pub. Date: Apr. 24, 2025

(54) ANTENNA MODULE AND ELECTRONIC DEVICE

(71) Applicant: COMPAL ELECTRONICS, INC., Taipei City (TW)

(72) Inventors: Liang-Che Chou, Taipei City (TW); Yu-Chun Hsieh, Taipei City (TW); Zhe-Kai Yang, Taipei City (TW); Hou-Lung Lin, Taipei City (TW); Jui-Hung Lai, Taipei City (TW)

(73) Assignee: COMPAL ELECTRONICS, INC., Taipei City (TW)

(21) Appl. No.: 18/916,715

(22) Filed: Oct. 16, 2024

Related U.S. Application Data
(60) Provisional application No. 63/544,957, filed on Oct. 20, 2023.

(51) Int. Cl. H01Q 5/48; H01Q 1/52

(52) U.S. Cl. CPC H01Q 5/48; H01Q 1/526

(57) ABSTRACT

An antenna module includes an antenna structure, a grounding plane, and an electromagnetic shielding structure. The antenna structure includes a radiating portion and a feeding portion coupled to each other. The grounding plane is adjacent to the antenna structure in a width direction of the antenna module. The feeding portion is coupled between the radiating portion and the grounding plane. The electromagnetic shielding structure is integrally connected to the grounding plane. In addition, an electronic device including the antenna module is also provided.

### CROSS-REFERENCE TO RELATED APPLICATION

This application claims the priority benefit of U.S. provisional application Ser. No. 63/544,957, filed on Oct. 20, 2023. The entirety of the above-mentioned patent application is hereby incorporated by reference herein and made a part of this specification.

### BACKGROUND

### Technical Field

The disclosure relates to an antenna module and an electronic device, and particularly relates to an antenna module including an electromagnetic shielding portion and an electronic device having the antenna module.

### Description of Related Art

With the development and popularization of wireless communication technology, most consumer electronic devices have the functions of mobile communication devices. For example, notebook computers are generally disposed with antenna modules for transmitting and receiving wireless signals. However, due to the thin, light, and compact design trend of notebook computers, the configuration space of the antenna module is limited. Therefore, how to configure an antenna module with good signal transmission performance in a limited space is an important issue in this field.

### SUMMARY

The disclosure provides an antenna module with good signal transmission performance.

The disclosure provides an electronic device whose antenna module has good signal transmission performance.

An antenna module of the disclosure includes an antenna structure, a grounding plane, and an electromagnetic shielding structure. The antenna structure includes a radiating portion and a feeding portion coupled to each other. The grounding plane is adjacent to the antenna structure in a width direction of the antenna module. The feeding portion is coupled between the radiating portion and the grounding plane. The electromagnetic shielding structure is integrally connected to the grounding plane.

An electronic device of the disclosure includes a device body and an antenna module. The antenna module is disposed on a device body and includes an antenna structure, a grounding plane, and an electromagnetic shielding structure. The antenna structure includes a radiating portion and a feeding portion coupled to each other. The grounding plane is adjacent to the antenna structure in a width direction of the antenna module. The feeding portion is coupled between the radiating portion and the grounding plane. The electromagnetic shielding structure is integrally connected to the grounding plane.

In an embodiment of the disclosure, the electromagnetic shielding structure includes an electromagnetic shielding portion, and there is a spacing between the electromagnetic shielding portion and the antenna structure in a length direction of the antenna module.

In an embodiment of the disclosure, the spacing is not less than 1 mm.

In an embodiment of the disclosure, a width of the electromagnetic shielding portion extending from the grounding plane in the width direction is not less than a width of the antenna structure extending from the grounding plane in the width direction.

In an embodiment of the disclosure, the electromagnetic shielding structure includes an electromagnetic shielding portion, and the electromagnetic shielding portion and the antenna structure have a spacing in the width direction.

In an embodiment of the disclosure, the spacing is not less than 3 mm.

In an embodiment of the disclosure, a thickness of the electromagnetic shielding structure in a thickness direction of the antenna module is not less than a thickness of the antenna structure in the thickness direction.

In an embodiment of the disclosure, the antenna module further includes an isolating portion, and the isolating portion is integrally connected to the grounding plane.

In an embodiment of the disclosure, there is a spacing in the width direction between the isolating portion and the antenna structure.

In an embodiment of the disclosure, the device body is a screen or a case of a notebook computer.

In an embodiment of the disclosure, the screen has a back cover, and the antenna structure, the grounding plane, and the electromagnetic shielding structure are directly disposed on the back cover.

In an embodiment of the disclosure, the antenna module further includes a shorting portion, the shorting portion is connected to the radiating portion, and the grounding plane is connected to the shorting portion.

Based on the above, in the antenna module of the disclosure, the antenna structure includes the electromagnetic shielding portion. Accordingly, the electromagnetic shielding portion may be used to shield the noise from the mainboard of the electronic device or other noise, and the reduction of the signal transmission performance of the antenna structure caused by the interference of the noise may be prevented thereby. Furthermore, in the antenna module of the disclosure, the electromagnetic shielding structure is integrally connected to the grounding plane, so that the antenna structure, the grounding plane, and the electromagnetic shielding structure may be integrally made of a single piece of metal material, and the structure of the antenna module may be streamlined and easily assembled with the device body thereby. Accordingly, the manufacturing and assembly costs of the antenna module may be reduced, and the antenna module including the electromagnetic shielding structure may be smoothly assembled in the limited configuration space of the device body.

### BRIEF DESCRIPTION OF THE DRAWINGS

FIG. 1 is a partial schematic diagram of an electronic device according to an embodiment of the disclosure.

FIG. 2 is a schematic diagram of the antenna module of FIG. 1.

FIG. 3 is a schematic diagram of an antenna module according to another embodiment of the disclosure.

FIG. 4 is a schematic diagram of an antenna module according to another embodiment of the disclosure.

FIG. 5 is a schematic diagram of an antenna module according to another embodiment of the disclosure.

FIG. 6 is a schematic diagram of an antenna module according to another embodiment of the disclosure.

FIG. 7 is a schematic diagram of an antenna module according to another embodiment of the disclosure.

FIG. 8 is a schematic diagram of an antenna module according to another embodiment of the disclosure.

FIG. 9 is a return loss diagram of the antenna module of FIG. 1.

### DESCRIPTION OF THE EMBODIMENTS

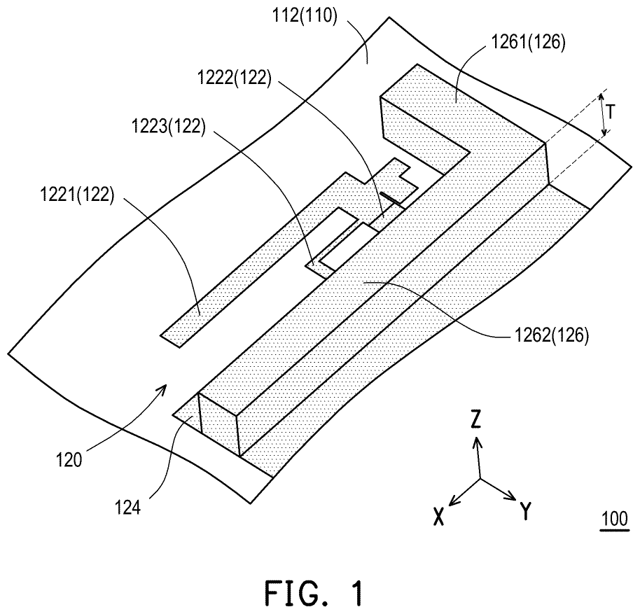

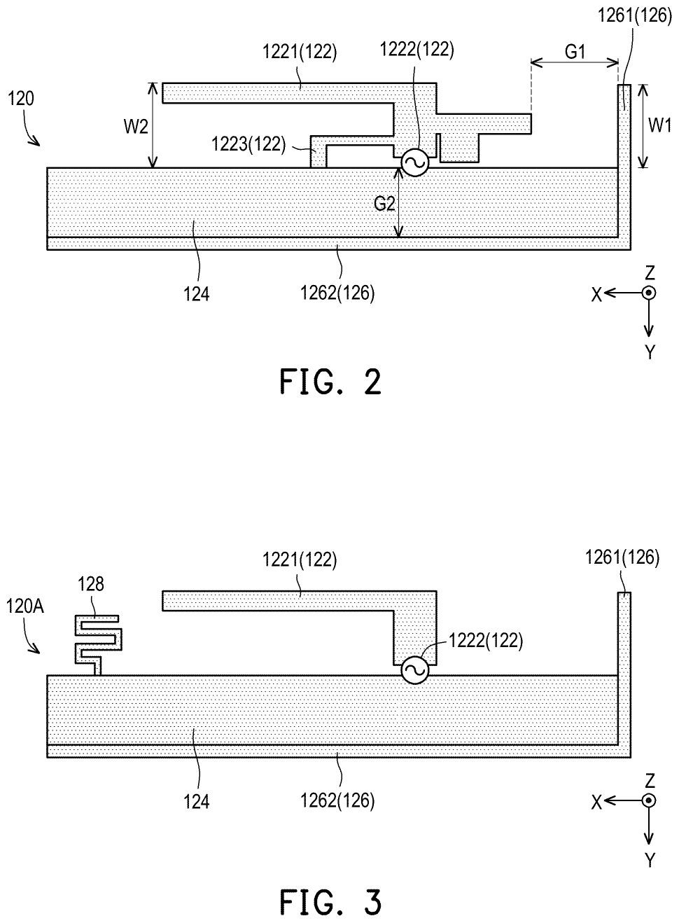

FIG. 1 is a partial schematic diagram of an electronic device according to an embodiment of the disclosure. FIG. 2 is a schematic diagram of the antenna module of FIG. 1. Referring to FIG. 1 and FIG. 2, an electronic device 100 of the embodiment includes a device body 110 and an antenna module 120. The antenna module 120 is disposed on the device body 110 and includes an antenna structure 122, a grounding plane 124, and an electromagnetic shielding structure 126. The antenna structure 122 includes a radiating portion 1221 and a feeding portion 1222 coupled to each other and a shorting portion 1223. The feeding portion 1222 is coupled between the radiating portion 1221 and the grounding plane 124. As used herein, “coupling” refers to a “direct connection” or an “indirect connection” between two components. For example, the “indirect connection” may be implemented through a cable connection. Specifically, the feeding portion 1222 is, for example, connected to the radiating portion 1221 and the grounding plane 124 through a cable.

The grounding plane 124 is adjacent to the antenna structure 122 in a width direction (axial direction Y) of the antenna module 120 and connected to the shorting portion 1223. The electromagnetic shielding structure 126 is integrally connected to the grounding plane 124. FIG. 3 is a schematic diagram of an antenna module according to another embodiment of the disclosure. In some embodiments, the antenna structure 122 may be in a form that does not include a shorting portion as shown in FIG. 3, and the disclosure is not limited thereto.

As mentioned above, in the antenna module 120 of the embodiment, the antenna structure 122 includes the electromagnetic shielding structure 126. Accordingly, the electromagnetic shielding structure 126 may be used to shield the noise from the mainboard of the electronic device 100 or other noise, and the reduction of the signal transmission performance of the antenna structure 122 caused by the interference of the noise may be prevented thereby. Furthermore, in the antenna module 120 of the embodiment, the electromagnetic shielding structure 126 is integrally connected to the grounding plane 124 as described above, so that the antenna structure 122, the grounding plane 124, and the electromagnetic shielding structure 126 may be integrally made of a single piece of metal material, and the structure of the antenna module 120 may be streamlined and easily assembled with the device body 110 thereby. Accordingly, the manufacturing and assembly costs of the antenna module 120 may be reduced, and the antenna module 120 including the electromagnetic shielding structure 126 may be smoothly assembled in the limited configuration space of the device body 100.

The device body 110 of the embodiment is, for example, a screen or a case of a notebook computer. The antenna structure 122, the grounding plane 124, and the electromagnetic shielding structure 126 may be directly disposed on a back cover 112 of the screen or the case (not shown) as shown in FIG. 1. Accordingly, there is no need to provide an additional substrate for carrying the antenna structure 122, the grounding plane 124, and the electromagnetic shielding structure 126, and the structure of the antenna module 120 may be simplified. In other embodiments, the device body 110 may be other types of electronic devices, and the antenna module 120 may be assembled thereon in other ways, and the disclosure is not limited thereto.

Referring to FIG. 2, specifically, the electromagnetic shielding structure 126 of the embodiment includes two electromagnetic shielding portions 1261 and 1262. For example, the two electromagnetic shielding portions 1261 and 1262 are connected to each other and bent to form an L shape, so as to effectively shield the noise when the noise mainly comes from the right and/or below of the antenna module 120. In other embodiments, the configuration of the electromagnetic shielding structure may be adjusted accordingly on the basis of the relative positional relationship between the noise source and the antenna module 120, and the disclosure is not limited thereto.

Furthermore, there is a spacing G1 between the electromagnetic shielding portion 1261 and the antenna structure 122 in a length direction (axial direction X) of the antenna module 120. In order to reduce the size of the antenna module 120, the spacing G1 needs to be as small as possible but, for example, not less than 1 mm. Accordingly, the electromagnetic shielding portion 1261 is not too close to the antenna structure 122, so as to avoid excessive capacitance and impedance mismatch due to the electromagnetic shielding portion 1261 being too close to the antenna structure 122. Furthermore, a width W1 of the electromagnetic shielding portion 1261 extending from the grounding plane 124 in the width direction (axial direction Y) is not less than a width W2 of the antenna structure 122 extending from the grounding plane 124 in the width direction (axial direction Y). Accordingly, the electromagnetic shielding portion 1261 has sufficient width to effectively exert the shielding effect.

On the other hand, the electromagnetic shielding portion 1262 and the antenna structure 122 have a spacing G2 in the width direction (axial direction Y). In order to reduce the size of the antenna module 120, the spacing G2 needs to be as small as possible but, for example, not less than 3 mm. Accordingly, the electromagnetic shielding portion 1262 is not too close to the antenna structure 122, so as to avoid excessive inductance and impedance mismatch due to the electromagnetic shielding portion 1262 connected to the grounding plane 124 being too close to the antenna structure 122.

In addition, as shown in FIG. 1, a thickness T of the electromagnetic shielding structure 126 of the embodiment in a thickness direction (axial direction Z) of the antenna module 120 is not less than a thickness of the antenna structure 122 in the thickness direction (axial direction Z). Accordingly, the electromagnetic shielding structure 126 has sufficient thickness to effectively exert the shielding effect.

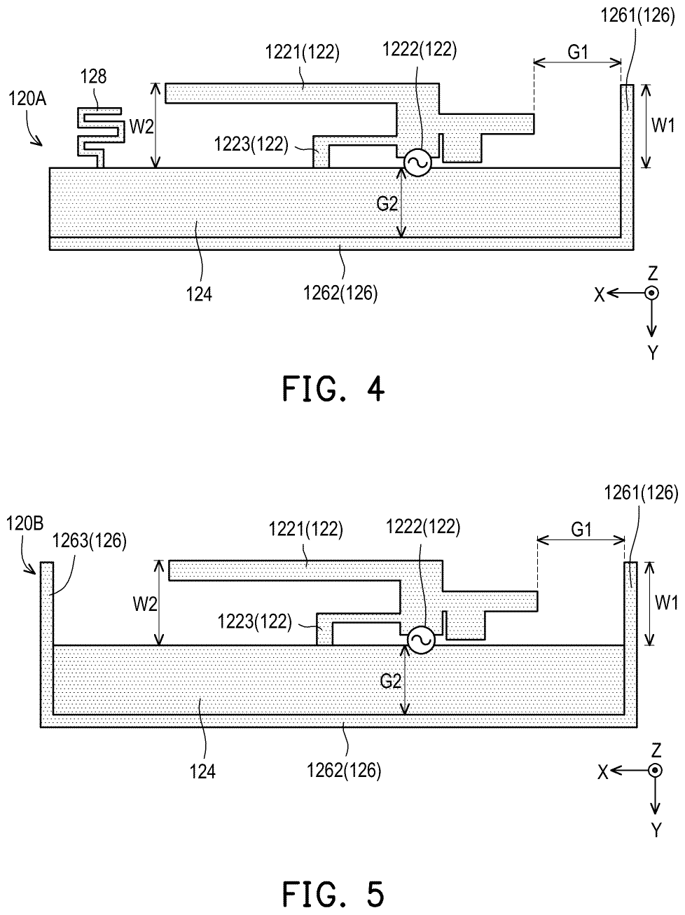

FIG. 4 is a schematic diagram of an antenna module according to another embodiment of the disclosure. The difference between an antenna module 120A shown in FIG. 4 and the antenna module 120 shown in FIG. 2 lies in that the antenna module 120A further includes an isolating portion 128. The isolating portion 128 is integrally connected to the grounding plane 124, and there is a spacing between the isolating portion 128 and the antenna structure 122 in the width direction (axial direction X). For example, the isolating portion 128 and the electromagnetic shielding portion 1261 are respectively located on two opposite sides of the antenna structure 122 in the width direction (axial direction X). The isolating portion 128 is used to provide good isolation between the antenna structure 122 and other antennas of the electronic device 100. The isolating portion 128 is, for example, zigzag-shaped and may have a sufficient extension length in a limited space. Specifically, the extension length of the isolating portion 128 is, for example, between one-quarter and one-half of the signal wavelength corresponding to the antenna structure 122, but the disclosure is not limited thereto.

FIG. 5 is a schematic diagram of an antenna module according to another embodiment of the disclosure. The difference between an antenna module 120B shown in FIG. 5 and the antenna module 120 shown in FIG. 2 lies in that the electromagnetic shielding structure 126 of the antenna module 120B further includes an electromagnetic shielding portion 1263. The electromagnetic shielding portions 1261 and 1263 are respectively connected to two opposite ends of the electromagnetic shielding portion 1262 to perform electromagnetic shielding on two opposite sides of the antenna structure 122 respectively. The configuration and function of the remaining portions of the antenna module 120B are the same or similar to those of the antenna module 120 and repeated description is omitted here.

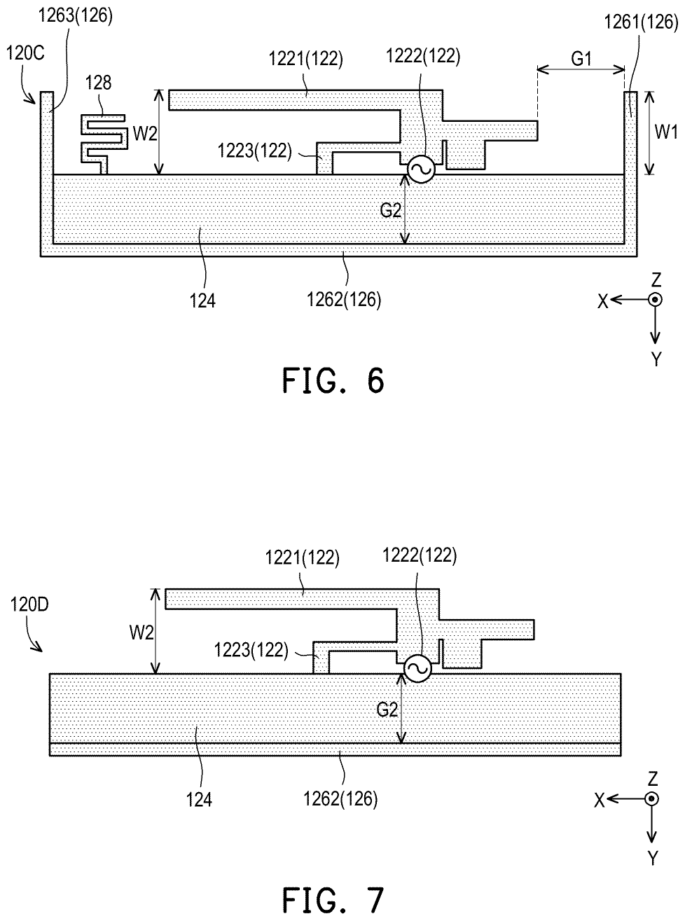

FIG. 6 is a schematic diagram of an antenna module according to another embodiment of the disclosure. The difference between an antenna module 120C shown in FIG. 6 and the antenna module 120B shown in FIG. 5 lies in that the antenna module 120C further includes the isolating portion 128. The configuration and function of the isolating portion 128 are the same as the isolating portion 128 shown in FIG. 4, and the configuration and function of the remaining portions of the antenna module 120C are the same or similar to those of the antenna module 120B, and repeated description is omitted here.

In the embodiments of FIG. 2 to FIG. 6, the electromagnetic shielding structure 126 may not include the electromagnetic shielding portion 1262.

FIG. 7 is a schematic diagram of an antenna module according to another embodiment of the disclosure. The difference between an antenna module 120D shown in FIG. 7 and the antenna module 120 shown in FIG. 2 lies in that the electromagnetic shielding structure 126 of the antenna module 120D does not include the electromagnetic shielding portion 1261 in FIG. 2.

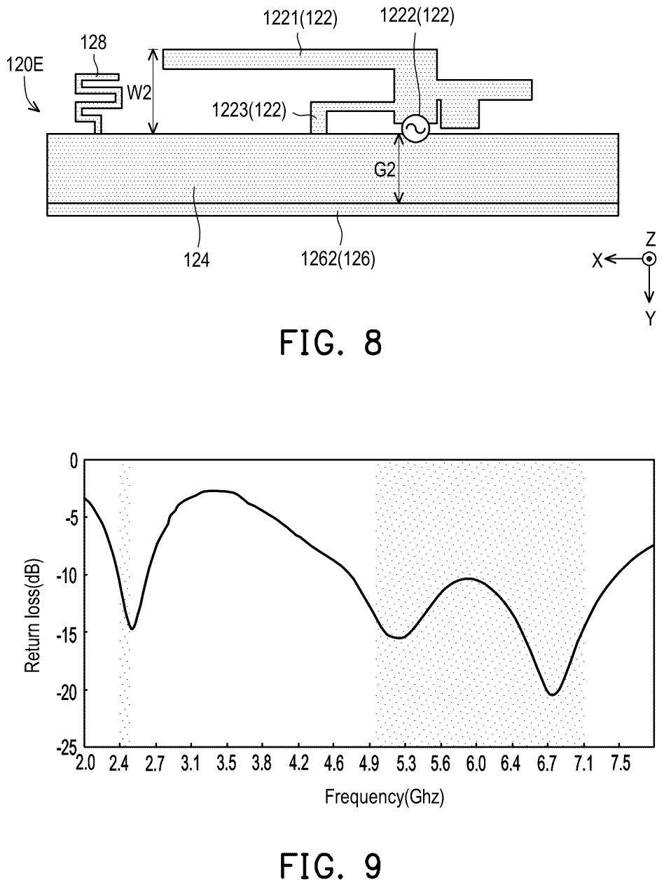

FIG. 8 is a schematic diagram of an antenna module according to another embodiment of the disclosure. The difference between an antenna module 120E shown in FIG. 8 and the antenna module 120D shown in FIG. 7 lies in that the antenna module 120E further includes the isolating portion 128. The configuration and function of the isolating portion 128 are the same as the isolating portion 128 shown in FIG. 4, and the configuration and function of the remaining portions of the antenna module 120E are the same or similar to those of the antenna module 120D, and repeated description is omitted here.

FIG. 9 is a return loss diagram of the antenna module of FIG. 1. As shown in FIG. 9, the antenna module 120 according to the embodiment of the disclosure may be well matched to the 2.4 Ghz, 5 Ghz, and 6 Ghz modes through the above configuration.

To sum up, in the antenna module of the disclosure, the antenna structure includes the electromagnetic shielding portion. Accordingly, the electromagnetic shielding portion may be used to shield the noise from the mainboard of the electronic device or other noise, and the reduction of the signal transmission performance of the antenna structure caused by the interference of the noise may be prevented thereby. Furthermore, in the antenna module of the disclosure, the electromagnetic shielding structure is integrally connected to the grounding plane, so that the antenna structure, the grounding plane, and the electromagnetic shielding structure may be integrally made of a single piece of metal material, and the structure of the antenna module may be streamlined and easily assembled with the device body thereby. Accordingly, the manufacturing and assembly costs of the antenna module may be saved, and the antenna module including the electromagnetic shielding structure may be smoothly assembled in the limited configuration space of the device body.

What is claimed is:

1. An antenna module, comprising:
an antenna structure, comprising a radiating portion and a feeding portion coupled to each other;
a grounding plane, adjacent to the antenna structure in a width direction of the antenna module, wherein the feeding portion is coupled between the radiating portion and the grounding plane; and
an electromagnetic shielding structure, integrally connected to the grounding plane.

2. The antenna module according to claim 1, wherein the electromagnetic shielding structure comprises an electromagnetic shielding portion, and there is a spacing between the electromagnetic shielding portion and the antenna structure in a length direction of the antenna module.

3. The antenna module according to claim 2, wherein the spacing is not less than 1 mm.

4. The antenna module according to claim 2, wherein a width of the electromagnetic shielding portion extending from the grounding plane in the width direction is not less than a width of the antenna structure extending from the grounding plane in the width direction.

5. The antenna module according to claim 1, wherein the electromagnetic shielding structure comprises an electromagnetic shielding portion, and the electromagnetic shielding portion and the antenna structure have a spacing in the width direction.

6. The antenna module according to claim 5, wherein the spacing is not less than 3 mm.

7. The antenna module according to claim 1, wherein a thickness of the electromagnetic shielding structure in a thickness direction of the antenna module is not less than a thickness of the antenna structure in the thickness direction.

8. The antenna module according to claim 1, further comprising an isolating portion, wherein the isolating portion is integrally connected to the grounding plane.

9. The antenna module according to claim 8, wherein there is a spacing in the width direction between the isolating portion and the antenna structure.

10. The antenna module according to claim 1, further comprising a shorting portion, wherein the shorting portion is connected to the radiating portion, and the grounding plane is connected to the shorting portion.

11. An electronic device, comprising:
a device body; and
an antenna module, disposed on the device body, and comprising:
an antenna structure, comprising a radiating portion and a feeding portion coupled to each other;
a grounding plane, adjacent to the antenna structure in a width direction of the antenna module, wherein the feeding portion is coupled between the radiating portion and the grounding plane; and
an electromagnetic shielding structure, integrally connected to the grounding plane.

12. The electronic device according to claim 11, wherein the electromagnetic shielding structure comprises an electromagnetic shielding portion, and there is a spacing between the electromagnetic shielding portion and the antenna structure in a length direction of the antenna module.

13. The electronic device according to claim 12, wherein the spacing is not less than 1 mm.

14. The electronic device according to claim 12, wherein a width of the electromagnetic shielding portion extending from the grounding plane in the width direction is not less than a width of the antenna structure extending from the grounding plane in the width direction.

15. The electronic device according to claim 11, wherein the electromagnetic shielding structure comprises an electromagnetic shielding portion, and the electromagnetic shielding portion and the antenna structure have a spacing in the width direction.

16. The electronic device according to claim 15, wherein the spacing is not less than 3 mm.

17. The electronic device according to claim 11, wherein a thickness of the electromagnetic shielding structure in a thickness direction of the antenna module is not less than a thickness of the antenna structure in the thickness direction.

18. The electronic device according to claim 11, wherein the antenna module further comprises an isolating portion, and the isolating portion is integrally connected to the grounding plane.

19. The electronic device according to claim 18, wherein there is a spacing in the width direction between the isolating portion and the antenna structure.

20. The electronic device according to claim 11, wherein the device body is a screen or a case of a notebook computer.

21. The electronic device according to claim 20, wherein the screen or the case has a back cover, and the antenna structure, the grounding plane, and the electromagnetic shielding structure are directly disposed on the back cover.

22. The electronic device according to claim 11, wherein the antenna module further comprises a shorting portion, the shorting portion is connected to the radiating portion, and the grounding plane is connected to the shorting portion.
